(19) United States
(12) Patent Application Publication
(10) Pub. No.: US 2006/0111506 A1
(43) Pub. Date: May 25, 2006

(54) Filled polyurethane dispersions

(76) Inventor: Bedri Erdem, Pearland, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/995,727

(22) Filed: Nov. 22, 2004

(51) Int. Cl. C08G 18/08

(52) U.S. Cl. 524/589

(57) ABSTRACT

Filled polyurethane dispersions having good tensile strength and elongation properties are comprised of water having therein particulate filler and polyurethane particles, wherein the polyurethane particles are comprised of a polyurethane having therein a elasticity rendering chain extension linkage of a low molecular weight polyoxypropylene diamine. These dispersions are useful for adhesives and carpet backings.

### FIELD OF THE INVENTION

The invention relates to improved particulate filled polyurethane dispersions and the articles made therefrom.

### BACKGROUND OF THE INVENTION

Polyurethanes are produced by the reaction of polyisocyanates and polyols or polyamines (compounds having an active hydrogen). Aqueous dispersions of polyurethane particles are known. For example, U.S. Pat. Nos. 2,968,575 and 3,294,724 describe aqueous polyurethane dispersions dispersed using a separately added surfactant. These polyurethane dispersions are commonly referred to as externally stabilized.

In addition, internally stabilized dispersions have been described. An internally stabilized polyurethane dispersion is one that is stabilized through the incorporation of tonically or nonionically hydrophilic pendant groups within the polyurethane of the particles dispersed in the liquid medium. Examples of nonionic internally stabilized polyurethane dispersions are described by U.S. Pat. Nos. 3,905,929 and 3,920,598, which contain pendant polyethylene oxide side chains.

Ionic internally stabilized polyurethane dispersions are well known and are described in col. 5, lines 4-68 and col. 6, lines 1 and 2 of U.S. Pat. No. 6,231,926 and U.S. Pat. Nos. 3,412,054; 3,479,310 and 4,066,591. Typically, dihydroxyalkylcarboxylic acids such as described by U.S. Pat. No. 3,412,054 are used to make anionic internally stabilized polyurethane dispersions. A common monomer used to make an anionic internally stabilized polyurethane dispersion is dimethylolpropionic acid (DMPA).

Polyurethane dispersions, typically, have been used to make coatings, which may act as adhesives bonding layers of other materials. In many of these applications the polyurethane coating of layer needs to be elastic enough to be bent or stretched without cracking or tearing, such as in a laminate coat on the back of a carpet. In addition, solid particle fillers have been added to polyurethanes from almost the beginning of the production of polyurethanes. The fillers have been added, for example, to color, change the density, modify mechanical properties and lower cost per unit volume of the polyurethane. Unfortunately, fillers tend to cause the polyurethane coating or laminate to become less elastic and thus more prone to cracking and tearing upon deformation (i.e., become more brittle). This in turn has reduced the amount of particle filler that can be incorporated into the polyurethane coating or laminate.

Consequently, it would be desirable to provide a polyurethane dispersion, that avoids the problems of the prior art, such as, limited filler loadings in polyurethane dispersion derived coatings due to embrittlement of the coating.

### SUMMARY OF THE INVENTION

The invention is directed to polyurethane dispersions that create elastic coatings with high solid particulate filler loadings.

A first aspect of the invention is a particulate filled polyurethane dispersion comprising: water having therein particulate filler and polyurethane particles, wherein the polyurethane particles are comprised of a polyurethane having therein a elasticity rendering chain extension linkage having the formula: 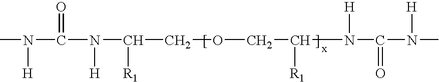
wherein each R₁ is independently H, a lower alkyl having from 1 to 2 carbons combination thereof and x has an average, by number within the polyurethane, of about 1 to about 4. Surprisingly, the particulate filled polyurethane dispersions of the present invention can form coatings having high particulate filler loadings while still remaining elastic without becoming soft and tacky. In addition, the present invention allows for excellent property development when cured at room temperature (e.g., within 10% of the tensile strength of a body cured at elevated temperatures ˜100° C. to 150° C.).

A second aspect of the invention is a particulate filled polyurethane article comprised of coalesced polyurethane particles and a particulate filler wherein the coalesced polyurethane particles are of a polyurethane having therein a chain extension linkage having the formula: 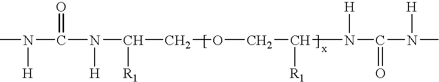
wherein each R₁ is independently H, or a lower alkyl having from 1 to 2 carbons and x has an average, by number within the polyurethane, of about 1 to about 4.

A third aspect of the invention is a method of forming a particulate filled polyurethane dispersion comprising:

(i) mixing an isocyanate terminated prepolymer in water in the presence of a chain extender to form a polyurethane dispersion, wherein at least a portion of the chain extender is an elasticity rendering chain extender having the formula: 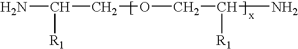
wherein each R₁ is independently H, or a lower alkyl having from 1 to 2 carbons and x is from about 1 to about 6 and x has an average, by number, of about 1 to about 4 such that the chain extender and isocyanate react such that at least some amount of the isocyanate terminated prepolymer reacts with elasticity rendering chain extender to form the polyurethane dispersion and

(ii) admixing a particulate filler into the polyurethane dispersion to form the particulate filled polyurethane dispersion.

The polyurethane dispersion is useful for applications that typically have utilized polyurethane. The polyurethane dispersion and polyurethane article made therefrom are particularly suitable for use as coatings, laminates, impregnating textiles, synthetic leather, flexible foams and the like for cushioning underlayments or backings for textile and non-textile flooring systems, adhesives and sealants.

### DETAILED DESCRIPTION OF THE INVENTION

The invention is a polyurethane dispersion that has high particulate filler loadings. This particulate filled polyurethane dispersion, surprisingly, forms elastic polyurethane articles upon coalescing the polyurethane particles and removing the water from the dispersion.

Particulate filler means herein any non-organic polymer solid essentially water insoluble particles suitable for use in polyurethane dispersion such as those known in the art. Exemplary particulate fillers include metals and ceramics (e.g., clays, oxides such as silica, titania, alumina, glasses such as soda lime silicate glass, and calcium carbonate). Fillers can include hollow particulates of metal and ceramics such as hollow glass spheres or spheroids. The particulates may be of any particulate morphology such as whiskers, spheres, spheroids, plates, and irregular ground or faceted particulates. Preferred fillers include calcium carbonate and glass particles.

Generally, the particulates have a median diameter of less than 1000 micrometers by volume. The particulate filler advantageously has a median particle size by volume of at most about 400 micrometers in diameter. Preferably the median particle size is at most about 300 micrometers, more preferably at most about 200 micrometers, even more preferably at most about 150 micrometers and most preferably at most about 100 micrometers to preferably at least about 1 micrometer and more preferably at least about 10 micrometers.

The amount of particulate filler in the particulate filled polyurethane dispersion may vary over a wide range depending, for example, on the properties and application, but is preferably highly loaded. Generally, the amount of particulate filler within the polyurethane dispersion corresponds to an amount of filler that results in a polyurethane article made therefrom ranging from about 10% to about 90% by volume of the polyurethane article. Preferably the amount of filler is at least about 15%, more preferably at least about 40%, even more preferably at least about 50%, and most preferably at least about 55%.

The polyurethane of the polyurethane particles may be any polyurethane suitable for making a polyurethane dispersion such as particles of polyurethane used in internally or externally stabilized polyurethane dispersions so long as there is a sufficient amount of elasticity rendering chain extension linkages within the polyurethane. Generally, a sufficient amount of such linkages is at least about 0.5% by weight of the polyurethane. Preferably the amount of such linkages is at least about 1%, more preferably at least about 2%, and most preferably at least about 5% to preferably at most about 20%, more preferably at most about 16% and most preferably at most about 13% by weight.

To reiterate, the polyurethane of the polyurethane particles may be any polyurethane suitable for making a polyurethane dispersion (internally and externally stabilized). An internally stabilized polyurethane dispersion is one that is stabilized through the incorporation of ionically or nonionically hydrophilic pendant groups within the polyurethane of the particles dispersed in the liquid medium. Examples of nonionic internally stabilized polyurethane dispersions are described by U.S. Pat. Nos. 3,905,929 and 3,920,598. Ionic internally stabilized polyurethane dispersions are well known and are described in col. 5, lines 4-68 and col. 6, lines 1 and 2 of U.S. Pat. No. 6,231,926. Typically, dihydroxyalkylcarboxylic acids such as described by U.S. Pat. No. 3,412,054 are used to make anionic internally stabilized polyurethane dispersions. A common monomer used to make an anionic internally stabilized polyurethane dispersion is dimethylolpropionic acid (DMPA).

An externally stabilized polyurethane dispersion may also be used. An externally stabilized polyurethane dispersion is one that substantially fails to have an ionic or nonionic hydrophilic pendant groups and thus requires the addition of a surfactant to stabilize the polyurethane dispersion. Examples of externally stabilized polyurethane dispersions are described in U.S. Pat. Nos. 2,968,575; 5,539,021; 5,688,842 and 5,959,027. Combinations of internally and externally stabilized polyurethane dispersion may be used.

The polyurethane dispersion may be mixed with other dispersed polymer particles so long as the majority of the polymer particles are polyurethane particles by volume. Other polymer dispersions or emulsions that may be useful when mixed with the polyurethane dispersion include polymers such as polyacrylates, polyisoprene, polyolefins, polyvinyl alcohol, nitrile rubber, natural rubber and co-polymers of styrene and butadiene. Most preferably, the polyurethane dispersion is the sole polymer particles present in the dispersion.

Preferably, the polyurethane dispersion is comprised of polyurethane particles of nonionizable polyurethane. Nonionizable polyurethane is a polyurethane that does not contain a hydrophilic ionizable group. A hydrophilic ionizable group is one that is readily ionized in water such as dimethylolpropionic acid (DMPA). Examples of other ionizable groups include anionic groups such as carboxylic acids, sulfonic acids and alkali metal salts thereof. Examples of cationic groups include ammonium salts reaction of a tertiary amine and strong mineral acids such as phosphoric acid, sulfuric acid, hydrohalic acids or strong organic acids or by reaction with suitable quartinizing agents such as C1-C6 alkyl halides or benzyl halides (for example, Br or Cl).

More preferably, the nonionizable polyurethane has no or an amount of ethylene oxide units that is insufficient to render a stable aqueous polyurethane dispersion in the absence of the external surfactant. An insufficient amount of ethylene oxide units means that a polyurethane dispersion having no external surfactant, would either not be able to be made in the first place, or would by unstable as defined previously (would coagulate or substantially alter its median particle size or viscosity after being stored for 2 weeks at room temperature).

If the nonionizable polyurethane contains ethylene oxide units, the amount of ethylene oxide units in the nonionizable polyurethane, generally, is at least about 0.1% to at most about 6% by weight of the nonionizable polyurethane. Preferably, the amount of ethylene oxide units is at least about 0.5%, more preferably at least about 0.75%, even more preferably at least about 1% and most preferably at least about 1.5% to preferably at most about 5.5%, more preferably at most about 5%, even more preferably at most about 4.5%, and most preferably at most about 4% by weight of the nonionizable polyurethane.

Ethylene oxide units herein means a group formed from ethylene oxide as shown by the following formula.
—CH₂—CH₂—O—

As necessary or desired the polyurethane may contain an external surfactant. The external surfactant may be cationic, anionic, amphoteric or nonionic. Suitable classes of surfactants include, but are not restricted to, sulfates of ethoxylated phenols such as poly(oxy-1,2-ethanediyl)α-sulfo-ω(nonylphenoxy) ammonium salt; alkali metal fatty acid salts such as alkali metal oleates and stearates; polyoxyalkylene nonionics such as polyethylene oxide, polypropylene oxide, polybutylene oxide, and copolymers thereof; alcohol alkoxylates; ethoxylated fatty acid esters and alkylphenol ethoxylates; alkali metal lauryl sulfates; amine lauryl sulfates such as triethanolamine lauryl sulfate; quaternary ammonium surfactants; alkali metal alkylbenzene sulfonates such as branched and linear sodium dodecylbenzene sulfonates; amine alkyl benzene sulfonates such as triethanolamine dodecylbenzene sulfonate; anionic and nonionic fluorocarbon surfactants such as fluorinated alkyl esters and alkali metal perfluoroalkyl sulfonates; organosilicon surfactants such as modified polydimethylsiloxanes; and alkali metal soaps of modified resins.

Preferably, the external surfactant is ionic. More preferably, the external surfactant is anionic. Exemplary preferred surfactants include disodium octadecyl sulfosuccinimate, sodium dodecylbenzene sulfonate, sodium stearate and ammonium stearate.

The amount of external surfactant, when present may be any suitable amount. Generally, the amount of external surfactant is about 0.1% to about 10% by weight of the total weight of the polyurethane dispersion. Preferably, the amount external surfactant is at least about 0.5%, more preferably at least about 1% and most preferably at least about 1.5% to preferably at most about 8%, more preferably at most about 7%, and most preferably at most about 6%, by weight of the total weight of the polyurethane dispersion.

In a preferred embodiment, the particulate filled polyurethane dispersion is one in which the dispersion is substantially free of organic solvents. Substantially free of organic solvents means that the dispersion was made without any intentional addition of organic solvents to make the prepolymer or the dispersion. That is not to say that some amount of solvent may be present due to unintentional sources such as contamination from cleaning the reactor. Generally, the aqueous dispersion has at most about 1 percent by weight of the total weight of the dispersion. Preferably, the aqueous dispersion has at most about 2000 parts per million by weight (ppm), more preferably at most about 1000 ppm, even more preferably at most about 500 ppm and most preferably at most a trace amount of a solvent. In a preferred embodiment, no organic solvent is used, and the aqueous dispersion has no detectable organic solvent present (i.e., “essentially free” of an organic solvent).

The particulate filled polyurethane dispersion may have, depending on the application, other suitable components such as those known in the art. For example, the polyurethane dispersion may have additives such as Theological modifiers, defoamers, antioxidants, pigments, dyes, and combinations thereof.

The particulate filled dispersion may have any suitable solids loading of polyurethane particles, which typically depends on the particular application. Generally, the solids loading of the polyurethane particles is at least about 20 percent to 80 percent solids by weight of the total solids weight of the dispersion (i.e., particulate filler+polyurethane particles). Preferably, the solids loading is at least 25 percent, more preferably at least 30 percent and most preferably at least 35 percent to preferably at most 75 percent, more preferably at most 70 percent and most preferably at most 65 percent by weight.

Generally, the particulate filled dispersion may have a viscosity that varies over a wide range depending on the solids loading of the polyurethane particles and particulate filler and any other additives that may be present. Desirably the polyurethane dispersion is easily pumped, while still being able to be cast and retain its shape to form a polyurethane article. Generally, the viscosity is from at least about 10 centipoise (cp) to at most about 40,000 cp as measured using a Brookfield Model RVDVE 115 viscometer employing a #6 spindle rotated at 20 revolutions per minute (rpm). Preferably, the viscosity is at least about 50 cp to at most about 30000 cp. More preferably, the viscosity is at least about 100 cp to at most about 25000 cp. The dispersion desirably may display non-Newtonian pseudo plastic behavior when used for certain applications such as carpet backing. This rheology, for example, resists filler fall-out, aids in coating placement and coating weight control.

The mean particle size by volume of the polyurethane particles generally is at most about 10 micrometers in diameter to at least about 0.01 micrometers. Preferably, the mean particle size is at most about 5 micrometers, more preferably at most about 2 micrometers and most preferably at most about 1 micrometer to preferably at least about 0.03, more preferably at least about 0.05 micrometer and most preferably at least about 0.1 micrometer.

Generally, in forming the polyurethane particles of the dispersion, an isocyanate terminated polyurethane/urea/thiourea prepolymer is reacted with a chain-extender in an aqueous medium, the chain extender being comprised of an elasticity rendering chain extender having the formula: 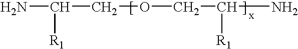
wherein R₁ is H, or a lower alkyl having from 1 to 2 carbons and x has an average, by number, of about 1 to about 4 where the amount of this chain extender is sufficient to render a polyurethane dispersion that can be highly loaded with particulate filler while still retaining elasticity upon coalescing the particles into a polyurethane article. Generally, x is from about 1 to about 6, but some molecules of the chain extender may have a number greater than 6, so long as the average x within the polyurethane is about 1 to 4. Preferably, the average of x is at least about 1.5, more preferably at least about 2, and most preferably at least about 2.3 to preferably at most about 3.5, more preferably at most about 3.2 and most preferably at most about 3. It is also preferred that R₁ is a methyl, ethyl or combination thereof, more preferably R₁ is methyl.

The elasticity rendering chain extender may be prepared by the methods described in U.S. Pat. No. 3,654,370. Suitable elasticity rendering chain extenders include those available from Huntsman LLC, Salt Lake City, Utah, under the trademark Jeffamine such as Jeffamine D-230.

It is understood that other chain extenders may be used so long as there is a sufficient amount of the elasticity rendering chain extender. Generally, the amount of the elasticity rendering chain extender is used in an amount of least about 10% of the NCO content (10% primary amino hydrogen to NCO groups) of the isocyanate terminated prepolymer. Preferably, the amount of the elasticity rendering chain extender is at least about 20%, more preferably 25%, even more preferably at least about 30% and most preferably at least 40% of the stoichiometric amount of the NCO content of the isocyanate prepolymer. Because water can react to chain extend the isocyanate prepolymer albeit at much slower reaction kinetics, the polyurethane particles may have chain extended linkages arising from being extended by water in neglible amounts regardless of the amount of elasticity render chain extender used.

Other chain extenders that may be used in addition to the elasticity rendering chain extender include, for example, water, amine terminated polyethers not falling within the above formula, amino ethyl piperazine, 2-methyl piperazine, 1,5-diamino-3-methyl-pentane, isophorone diamine, ethylene diamine, diethylene triamine, triethylene tetramine, triethylene pentamine, ethanol amine, lysine in any of its stereoisomeric forms and salts thereof, hexane diamine, hydrazine and piperazine. In a particularly preferred embodiment, the elasticity rendering chain extender and water are the sole chain extenders.

The isocyanate terminated polyurethane/urea/thiourea prepolymer can be prepared by any suitable method such as those well known in the art. The prepolymer is advantageously prepared by contacting a high molecular weight organic compound having at least two active hydrogen atoms with sufficient polyisocyanate, and under such conditions to ensure that the prepolymer is isocyanate terminated as described in U.S. Pat. No. 5,959,027, incorporated herein by reference.

The polyisocyanate is preferably an organic diisocyanate, and may be aromatic, aliphatic, or cycloaliphatic, or a combination thereof. Representative examples of diisocyanates suitable for the preparation of the prepolymer include those disclosed in U.S. Pat. No. 3,294,724, column 1, lines 55 to 72, and column 2, lines 1 to 9, incorporated herein by reference, as well as U.S. Pat. No. 3,410,817, column 2, lines 62 to 72, and column 3, lines 1 to 24, also incorporated herein by reference. Preferred diisocyanates include 4,4′-diisocyanatodiphenylmethane, 2,4′-diisocyanatodiphenylmethane, isophorone diisocyanate, p-phenylene diisocyanate, 2,6 toluene diisocyanate, polyphenyl polymethylene polyisocyanate, 1,3-bis(isocyanatomethyl)cyclohexane, 1,4-diisocyanatocyclohexane, hexamethylene diisocyanate, 1,5-naphthalene diisocyanate, 3,3′-dimethyl-4,4′-biphenyl diisocyanate, 4,4′-diisocyanatodicyclohexylmethane, 2,4′-diisocyanatodicyclohexylmethane, and 2,4-toluene diisocyanate, or combinations thereof. More preferred diisocyanates are 4,4′-diisocyanatodicyclohexylmethane, 4,4′-diisocyanatodiphenylmethane, 2,4′-diisocyanatodi-cyclohexylmethane, and 2,4′-diisocyanatodiphenylmethane. Most preferred are 4,4′-diisocyanatodiphenylmethane, 2,4′-diisocyanatodiphenylmethane and combination thereof.

As used herein, the term “active hydrogen group” refers to a group that reacts with an isocyanate group to form a urea group, a thiourea group, or a urethane group as illustrated by the general reaction:

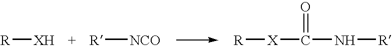

where X is O, S, NH, or N, and R and R′ are connecting groups which may be aliphatic, aromatic, or cycloaliphatic, or combinations thereof. The high molecular weight organic compound with at least two active hydrogen atoms typically has a molecular weight of not less than 500 Daltons.

The high molecular weight organic compound having at least two active hydrogen atoms may be a polyol, a polyamine, a polythiol, or a compound containing combinations of amines, thiols, and ethers. Depending on the properties desired the polyol, polyamine, or polythiol compound may be primarily a diol, triol or polyol having greater active hydrogen functionality or a mixture thereof. It is also understood that these mixtures may have an overall active hydrogen functionality that is slightly below 2, for example, due to a small amount of monol in a polyol mixture.

Preferably, the high molecular weight organic compound having at least two active hydrogen atoms is a polyalkylene glycol ether or thioether or polyester polyol or polythiol having the general formula:

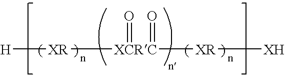

where each R is independently an alkylene radical; R′ is an alkylene or an arylene radical; each X is independently S or O, preferably O; n is a positive integer; and n′ is a non-negative integer.

Generally, the high molecular weight organic compound having at least two active hydrogen atoms has a weight average molecular weight of at least about 500 Daltons, preferably at least about 750 Daltons, and more preferably at least about 1000 Daltons. Preferably, the weight average molecular weight is at most about 20,000 Daltons, more preferably at most about 10,000 Daltons, more preferably at most about 5000 Daltons, and most preferably at most about 3000 Daltons.

Polyalkylene ether glycols and polyester polyols are preferred. Representative examples of polyalkylene ether glycols are polyethylene ether glycols, poly-1,2-propylene ether glycols, polytetramethylene ether glycols, poly-1,2-dimethylethylene ether glycols, poly-1,2-butylene ether glycol, and polydecamethylene ether glycols. Preferred polyester polyols include polybutylene adipate, caprolactone based polyester polyol and polyethylene terephthalate.

The NCO:XH ratio may be any suitable to form a polyurethane dispersion. Preferably the NCO:XH ratio is not less than 1.1:1, more preferably not less than 1.2:1, and preferably not greater than 5:1.

The polyurethane prepolymer may be prepared by a batch or a continuous process. Useful methods include methods such as those known in the art. For example, a stoichiometric excess of a diisocyanate and a polyol can be introduced in separate streams into a static or an active mixer at a temperature suitable for controlled reaction of the reagents, typically from about 40° C. to about 100° C. A catalyst may be used to facilitate the reaction of the reagents such as an organotin catalyst (e.g., stannous octoate). The reaction is generally carried to substantial completion in a mixing tank to form the prepolymer.

The polyurethane dispersion may be prepared by any suitable method such as those well known in the art. (See, for example, U.S. Pat. No. 5,539,021, column 1, lines 9 to 45, which teachings are incorporated herein by reference.)

When making the polyurethane dispersion, the prepolymer is at least partially extended by the elasticity rendering chain extender. The elasticity rendering chain extender is, preferably, dissolved in the water used to make the dispersion prior to addition of the prepolymer.

In making the particulate filled polyurethane dispersion, particulate filler may be added at any suitable time in the process of making the polyurethane dispersion. Preferably, the particulate filler is added after the polyurethane dispersion has been formed.

Once the particulate filled dispersion is formed a polyurethane object may be made therefrom. The polyurethane object may be made by any known method to form objects from a polyurethane dispersion. For example the dispersion may be coated upon a substrate and then dried at room temperature or an elevated temperature. In addition other shapes and forms may be made in a like manner such as drawing a fiber.

Generally, the polyurethane article is characterized by a microstructure that shows domains where the particles have coalesced (fused together wherein the particles have some intermingling-entanglement of their polymer chains, for example, due to heating such that the chains have enough mobility to intermingle such that the particles fuse together). That is these polyurethane articles display a distinct grain boundary region between fused polyurethane particles.

Surprisingly, the particulate filled polyurethane article (e.g., coating, elastomer, sealant, or adhesive) has good elasticity without becoming soft or tacky. This is so, even though the article has a particulate filler content in excess of 50% by volume of the final composite and even when the particulate filler content is in excess of 75% by volume of the final composite. It is believed that the type of chain extending agent may change the surface polarity of the particles, solubility of the hard segment in the soft segment and/or alters the strength of the hard segments in some way such that a high filler loading may be achieved without sacrificing toughness and flexibility of the resultant polyurethane film or body.

### EXAMPLES

Each of the following Examples and Comparative Examples uses the following prepolymer. About 447 parts by weight (pbw) of VORANOL* 222-056 (a 2000 molecular weight “MW” polyoxypropylene diol having a total of 12.5 percent ethylene oxide by weight end capping available from The Dow Chemical Company, Midland, Mich.), about 16 pbw of CARBOWAX* 1000 (a polyethylene glycol having a MW range of about 950 to 1050 available from The Dow Chemical Company), and about 16 pbw of a methoxypolyethylene glycol, a polyether monol having a molecular weight of about 950, are placed in a flask which is placed in an oven held at 70° C. for 30 minutes. To this mixture, about 289 pbw of ISONATE* 125M (diphenylmethane diisocyante having about 97% 4,4′-diphenylmethane diisocyanate and about 3% 2,4′-diphenylmethane diisocyanate, available from The Dow Chemical Company). The mixture is vigorously stirred for 30 minutes and then placed in the oven at 70° C. for about 12 hours. The NCO content of the resultant prepolymer is about 6.9 percent by weight.

### Examples 1

A polyurethane dispersion is made using the above prepolymer by the same process as described in the Example of U.S. Pat. No. 6,087,440 except that the chain extender is JEFFAMINE D230 pbw, available from Huntsman LLC, Houston, Tex., which is added in an amount equal to about 50 percent of the stoichiometric amount of the NCO content of the prepolymer. JEFFAMINE D230 has an average x of about 2.6 in the below formula previously described herein:

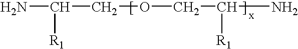

A carpet backing formulation consisting of 100 parts by weight (pbw of polyurethane solids) of the above polyurethane dispersion, 200 pbw calcium carbonate and 0.2 pbw ACRYSOL® RM-8W thickener, Rohm and Haas Company, Philadelphia, Pa., is prepared by simple paddle stirring. Such a dispersion has 200 pph (parts per hundred by weight of polyurethane solids). The carpet backing formulation is adjusted to have solids loading of about 80% by weight.

The formulation is then coated onto a carpet construction by drawing down the PUD formulation on the carpet construction. The carpet construction consists of nylon yarn tufted into woven polypropylene fabric. The coating is dried at 130° C. in a convection oven. After drying, the coated carpet sample is reheated to 130° C. and a PVC rolled good (sheet) preheated to a temperature of 80° C. is laminated using a roller. The tuft bind of the resulting carpet as determined by ASTM 1335, is shown in Table 1.

### Example 2-4

Examples 2-4 are made in the same way as Example 1 except that different loadings of calcium carbonate are used as shown in Table 1 along with resultant tuft bind of the carpets.

### Comparative Examples 1-4

Comparative Examples 1-4 are made in the same way as the Example described in U.S. Pat. No. 6,087,440 except that the filler loading is as shown in Table 1. The resulting tuft bind of these are shown in Table 1.

### Comparative Examples 5 and 6

Comparative examples 5 and 6 are made the same way as Example 1, except that the chain extender is solely water and the solids loading is as shown in Table 1. The results for these Comparative Examples also appear in Table 1.

From Table 1, it is evident that the tuft bind and durability of the carpet is greatly improved when using a filled polyurethane dispersion chain extended with property enhancing chain extender of the invention compared to a filled polyurethane disperion not chain extended with the property enhancing chain extender of the invention.

TABLE 1
Carpet Tuft Bind

| | Calcium | Tuft | |
|---|---|---|---|
| | Carbonate | bind | Durability |
| Example | Loading (pph) | (lB) | (roll stool test*) |
| 1 | 200 | 18.2 | PASS-No cracking |
| 2 | 260 | 14.6 | PASS-No cracking |
| 3 | 360 | 14.5 | PASS-No cracking |
| 4 | 525 | 12.8 | PASS-No cracking |
| Comparative 1 | 200 | 14.9 | PASS-No cracking |
| Comparative 2 | 260 | 11.8 | FAIL-minor |
| | | | cracking |
| Comparative 3 | 360 | 9.8 | FAIL-Severe |
| | | | cracking |
| Comparative 4 | 525 | 8.0 | FAIL-Severe |
| | | | cracking |
| Comparative 5 | 200 | 14.8 | PASS-No cracking |
| Comparative 6 | 400 | 12.0 | FAIL-Cracking |

*25,000 cycles rolling (with a CASTER WHEEL CHAIR) constant load (100 kg weight) on a carpet sample.

### Examples 5 and 6

Polyurethane dispersions are made in the same way as in Example 1 except that the chain extenders used are those shown in Table 2. It is understood that the balance of the chain extender is attributed to water (i.e., water is the chain extender for the balance of the NCO). To the dispersion is added 400 pph of calcium carbonate filler. The dispersion is cast and dried at 130° C. for 20 minutes to form a film. The films have the properties shown in Table 2.

### Comparative Examples 7-9

Polyurethane dispersions and films are made in the same way as Examples 5 and 6 except that the chain extenders used are shown in Table 1. JEFFAMINE A400, available from Huntsman LLC has an average x of 6.1 in the formula presented in Example 1. The chain extender, amounts of chain extenders and properties of the films are shown in Table 2.

From Table 2 it is evident that the use of even a relatively small amount of the property enhancing chain extender of this invention (JEFFAMINE D230), results in highly filled films with much improved tensile strength along with excellent elongation. In addition, the dispersions of Comparative Examples 7 and 8, when used to make a carpet as described above, resulted in a Tuft bind that was insufficient, because of the softness of the resulting polymer. The dispersion of Comparative Example 9, when used to make carpet as described above cracked during durability testing.

TABLE 2
Filled Polyurethane Films

| | | Jeffamine | Jeffamine | Film | |
|---|---|---|---|---|---|
| | Piperazine | 230 | 400 | Tensile | Film |
| | (% of | (% of | (% of | strength | Elongation |
| Example | NCO) | NCO) | NCO) | (psi) | (%) |
| 5 | 10 | 40 | 0 | 263 | 89 |
| 6 | 30 | 20 | 0 | 311 | 57 |
| Comparative 7 | 10 | 0 | 40 | 144 | 79 |
| Comparative 8 | 30 | 0 | 20 | 173 | 71 |
| Comparative 9 | 60 | 0 | 0 | 238 | 7 |

What is claimed is:

1. A particulate filled polyurethane dispersion comprising: water having therein particulate filler and polyurethane particles, wherein the polyurethane particles are comprised of a polyurethane having therein an elasticity rendering chain extension linkage having the formula: 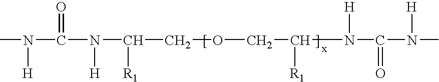
wherein each R₁ is independently H or a lower alkyl having from 1 to 2 carbons and x has an average, by number, within the polyurethane, of about 1 to about 4.

2. The particulate filled polyurethane dispersion of claim 1 wherein x has an average of about 1.5 to about 3.5.

3. The particulate filled polyurethane dispersion of claim 2, wherein x has an average of about 2 to about 3.

4. The particulate filled polyurethane dispersion of claim 1, wherein R₁ is methyl, ethyl or combination thereof.

5. The particulate filled polyurethane dispersion of claim 4, wherein R₁ is methyl.

6. The particulate filled polyurethane dispersion of claim 1, wherein the amount of elasticity rendering chain extension linkages within the polyurethane is at least 2% to at most about 16% by weight of the polyurethane.

7. The particulate filled polyurethane dispersion of claim 1, wherein the elasticity rendering chain extension linkages within the polyurethane is at least about 5 to at most about 13% by weight of the polyurethane.

8. The particulate filled polyurethane dispersion of claim 1, wherein the particulate filler is present in an amount of about 40% to about 90% by weight of the total solids weight of the dispersion.

9. The particulate filled polyurethane dispersion of claim 8, wherein the particulate filler is present in an amount of at least about 50% by volume.

10. The particulate filled polyurethane dispersion of claim 9, wherein the particulate filler is present in an amount of at least 50%. by volume of the article.

11. A particulate filled polyurethane article comprised of coalesced polyurethane particles and a particulate filler wherein the coalesced polyurethane particles are of a polyurethane having therein an elasticity rendering chain extension linkage having the formula: 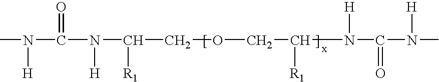
wherein each R₁ is independently H, or a lower alkyl having from 1 to 2 carbons and x has an average, by number within the polyurethane, of about 1 to about 4.

12. The particulate filled polyurethane article of claim 12, wherein the average of x is about 1.5 to about 3.

13. The particulate filled polyurethane article of claim 12, wherein the average of x is at least about 2.

14. The particulate filled polyurethane article of claim 11, wherein the polyurethane has at least about 2% by weight of the elasticity rendering chain extension linkage.

15. The particulate filled polyurethane article of claim 11, wherein the polyurethane has at least about 5% by weight of the elasticity rendering chain extension linkage.

16. The particulate filled polyurethane article of claim 11, wherein the polyurethane is of an aromatic polyisocyanate.

17. The particulate filled polyurethane article of claim 16, wherein the aromatic polyisocyanate is 4,4′-diisocyanatodiphenylmethane, and 2,4′-diisocyanatodiphenylmethane, 2,6 toluene diisocyanate, 2,4 toluene diisocyanate or combination thereof.

18. The particulate filled polyurethane article of claim 17, wherein the aromatic polyisocyanate is 4,4′-diisocyanatodiphenylmethane, and 2,4′-diisocyanatodiphenylmethane or combination thereof.

19. A method of forming a particulate filled polyurethane dispersion comprising:
(i) mixing an isocyanate terminated prepolymer in water in the presence of a chain extender to form a polyurethane dispersion of dispersed polyurethane particles, wherein at least a portion of the chain extender is an elasticity rendering chain extender having the formula: 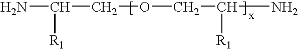
wherein each R₁ is independently H, or a lower alkyl having from 1 to 2 carbons and x is from about 1 to about 6 and x has an average, by number, of about 1 to about 4 such that the chain extender and isocyanate react such that at least about 50% of the isocyanate terminated prepolymer reacts with elasticity rendering chain extender to form the polyurethane dispersion and
(ii) admixing a particulate filler into the polyurethane dispersion to form the particulate filled polyurethane dispersion.

20. The method of claim 19, wherein x is from 1 to 5.

21. The method of claim 19, wherein the average of x is from about 1.5 to about 3.

22. The method of claim 21, wherein the average of x is at least about 2.

23. The method of claim 19, wherein at least about 20% of the chain extender is the elasticity rendering chain extender.

24. The method of claim 23, wherein at least about 40% of the chain extender is the elasticity rendering chain extender.

25. The method claim 24, essentially all of the chain extender is the elasticity rendering chain extender.

27. The method of claim 19, wherein the particulate filler is present in an amount of at least about 50% by volume of the volume of the polyurethane particles and particulate filler volume.

28. The method of claim 27, wherein the particulate filler is present in an amount of at least about 55% by volume of the volume of the polyurethane particles and particulate filler volume.

29. The method of claim 28, wherein the polyurethane particles of the polyurethane dispersion are nonionizable polyurethane.

30. The method of claim 29, wherein the dispersion has an external surfactant.

31. The method of claim 30, wherein the external surfactant is an anionic surfactant.
